(19) United States
(12) Patent Application Publication
(10) Pub. No.: US 2025/0362383 A1
(43) Pub. Date: Nov. 27, 2025

(54) Method For Determining At Least One Item Of Target Information Of A Target Object Of A Sensor System On The Basis Of A Surroundings Reconstruction Of The Surroundings Of The Sensor System, As Well As Sensor System And Vehicle

(71) Applicant: Volkswagen Aktiengesellschaft, Wolfsburg (DE)

(72) Inventors: Heiko Gustav Kurz, Hannover (DE); Thomas Gisder, Wolfsburg (DE); Marc-Michael Meinecke, Sassenburg (DE)

(73) Assignee: Volkswagen Aktiengesellschaft, Wolfsburg (DE)

(21) Appl. No.: 19/056,448

(22) Filed: Feb. 18, 2025

(30) Foreign Application Priority Data
Feb. 19, 2024 (DE) 10 2024 201 503.2

(51) Int. Cl. G01S 7/41; G01S 13/02; G01S 13/40; G01S 13/89

(52) U.S. Cl. CPC G01S 7/41; G01S 13/40; G01S 13/89; G01S 2013/0245

(57) ABSTRACT

The disclosure relates to a method for determining at least one item of target information of a target object of a sensor system, which has multiple transmitting antennas and multiple receiving antennas, wherein in a transmission process, multiple electrical emitted signals, which are frequency shifted relative to one another, are emitted simultaneously by the multiple transmitting antennas into the surroundings, electrical receive signals, which are based on the emitted signals, are received by the multiple receiving antennas, a virtual antenna array which has multiple virtual receiving antennas is generated by antenna positions of the multiple transmitting antennas and by antenna positions of the multiple receiving antennas, on the basis of the received electrical receive signals, a surroundings reconstruction of the surroundings is performed on the basis of the virtual antenna array, and the at least one item of target information is determined on the basis of the surroundings reconstruction.

### CROSS-REFERENCE TO RELATED APPLICATIONS

This application claims priority to German Patent Application DE 10 2024 201 503.2, filed on Feb. 19, 2024 with the German Patent and Trademark Office. The contents of the aforesaid patent application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a method for determining at least one item of target information of a target object of a sensor system which has multiple transmitting elements and multiple receiving elements.

Moreover, the disclosure relates to a sensor system having multiple transmitting antennas, multiple receiving antennas and one electronic computing apparatus.

Moreover, the disclosure relates to a vehicle having a corresponding sensor system.

### SUMMARY

A need exists to provide an improved capturing of a target object in the surroundings of a sensor system by establishing more comprehensive information relating to the target object and the surroundings.

The need is addressed by the subject matter of the independent claim(s). Embodiments of the invention are described in the dependent claims, the following description, and the drawings.

### BRIEF DESCRIPTION OF THE DRAWINGS

FIG. 1 shows a schematic representation of an example vehicle having an example sensor system which has antenna elements of an antenna array arranged in a distributed manner on the vehicle;

FIG. 2 shows a schematic representation of a block diagram of the example sensor system from FIG. 1;

FIG. 3 shows a schematic representation of the example vehicle from FIG. 1, wherein a real antenna array and an associated virtual antenna array for capturing the environment are shown;

FIG. 4 shows an example representation of the vehicle during travel by locomotion, wherein a simultaneous transmission of frequency-shifted signals is effected at respective measuring positions in order to produce a grid model with respect to the space to be reconstructed;

FIG. 5 shows a schematic representation of example emitted signals of the transmission process, which are frequency shifted relative to one another;

FIG. 6 shows, starting from FIG. 5, a further example representation of the emitted signals, wherein the signals overlap in modulation regions;

FIG. 7 shows a schematic representation of an example transmitting apparatus, to which the multiple transmitting antennas can belong;

FIG. 8 shows a schematic representation of the example receiving apparatus which can have, for example, multiple receiving antennas;

FIG. 9 shows an example representation of the virtual antenna array, which can have a plurality of virtual receiving antennas which have been generated on a computer-based basis;

FIG. 10 shows a schematic representation of partial spectrums of a distance spectrum of a virtual receiving antenna;

FIG. 11 shows a schematic representation of an example grid model with respect to the surroundings reconstruction, wherein information is transferred to individual regions of the grid model, here, on the basis of the partial spectrums;

FIG. 12 shows, starting from FIG. 11, a detailed view of how the individual partial spectrums are projected into the grid model;

FIG. 13 schematically shows how the respective partial spectrums are filtered in terms of the grid model in order to compensate for the respective phase positions regarding the grid model; and

FIG. 14 shows an example procedure for reconstructing the surroundings on the basis of a virtual antenna array.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Some embodiments relate to a method for determining at least one item of target information of a target object of a sensor system which has multiple transmitting antennas and multiple receiving antennas, wherein:
In particular, in a transmission process, multiple electrical emitted signals, which are frequency shifted relative to one another, are emitted simultaneously by the multiple transmitting antennas into the surroundings,
In particular, electrical receive signals, which are based on the emitted electrical emitted signals, are received by the multiple receiving antennas,
In particular, a virtual antenna array which has multiple virtual receiving antennas is generated by antenna positions of the multiple transmitting antennas and by antenna positions of the multiple receiving antennas on the basis of the received electrical receive signals,
In particular, a surroundings reconstruction of the surroundings is performed on the basis of the virtual antenna array, and
In particular, the at least one item of target information is determined on the basis of the surroundings reconstruction.

Thanks to the proposed method, a sensor system can be deployed more efficiently and, in particular, in a more versatile manner, since target information of a target object in the surroundings of the sensor system can be captured better, in particular more precisely. The virtual antenna array can be generated by the simultaneous emission or, respectively outputting of multiple electrical emitted signals, which are frequency shifted relative to one another, into the surroundings per request-to-transmit. In other words, one electrical emitted signal or, respectively transmit signal is emitted in each case per transmission process by the sensor system having multiple or having a predefined number of transmitting antennas, that is to say transmitting elements. These electrical emitted signals have different frequencies, so that the electrical emitted signals are frequency shifted relative to one another. Thanks to the simultaneous transmission or, respectively outputting of the electrical emitted signals, which are frequency shifted relative to one another, an improved and, in particular, more efficient production of a virtual antenna array can be performed. The production of virtual antenna arrays is in particular beneficial for signal processing and, consequently, for capturing the environment.

On the basis of the emitted and received signals, multiple virtual antenna elements or, respectively one virtual antenna array can be spanned, so that the resolution of the sensor system can, for example, be increased as a result.

The electrical emitted signals emitted in the surroundings of the transmission system can in turn be reflected accordingly, so that at least some electrical receive signals, which correspond to the electrical emitted signals, are received by multiple or at least some of the multiple receiving antennas.

The terms ‘electrical emitted signals’, ‘electrical receive signal’, and ‘signal’ generally are understood herein to refer to electromagnetic signals, in particular when emitted/sent and received by the antennas.

For the generation or, respectively production of the virtual antenna array, in particular by the system, the received electrical signals, the respective real antenna positions of the multiple, in particular real, transmitting antennas and the real antenna positions of the multiple, in particular real, receiving antennas, can be taken into account.

Most notably, the virtual antenna array offers the benefit that, compared to the real antennas of a real antenna array, it can have more transmitting antennas and more receiving antennas. Consequently, the number of the virtual transmitting antennas and the virtual receiving antennas is greater, for example many times greater, than the number of the real transmitting antennas and the real receiving antennas. As a result, the real sensor system can be used and manufactured more simply and, in particular, at reduced cost. In order to obtain more comprehensive information regarding the target object, in particular regarding the surroundings and, for example, to expand target information relating to potential target objects in its information content, a surroundings reconstruction can be conducted with the virtual antenna array. To this end, in addition to the one transmission process performed, a plurality of consecutively performed transmitting processes and the corresponding emitted and received signals can, moreover, be taken into account. Most notably, a capturing of a spatial extent of the target object in the surroundings such as, by way of example, in the vehicle surroundings can be performed, as a result, during deployment of the sensor system in the automotive sector. Thanks to the surroundings reconstruction, that is to say, of a virtual three-dimensional modeling of the surroundings based on the virtual antenna array, extended structures, such as target objects, in the surroundings of the sensor system can be reliably captured. Thanks to the surroundings reconstruction, a height profile of these structures, such as of the target object, can be better estimated, for example.

In particular, the present method offers benefits in increasing the comfort in terms of the capturing process and, for example, improving the reliability of the sensor system independently of the weather conditions in the surroundings of the sensor system. Thanks to the virtual antenna array and the surroundings reconstructions produced or, respectively performed therewith, a robust process of capturing the environment for mapping and localization can be conducted. Thanks to the simultaneous outputting of frequency-shifted signals and the virtual antenna array generated as a result, a detection of descriptors within a three-dimensional surroundings model, such as the surroundings reconstruction, can be performed for mapping and localization.

The proposed method may particularly be useful when the sensor system is deployed in the automotive sector. There, the sensor system may be used primarily to detect objects located next to the vehicle, in particular moving objects, when a vehicle is moving, that is to say, during the travel by locomotion of the vehicle. In this case, the transmitting antennas and the receiving antenna can be arranged on the side of the vehicle such as, by way of example, along the B-pillar, with the aid of the proposed method. Consequently, emitting laterally from the vehicle, that is to say with respect to the front passenger side and the front, the environment can be captured in an improved manner.

For the surroundings reconstruction, that is to say the modeling of the three-dimensional virtual surroundings on the basis of the real surroundings, the simultaneous transmission of the emitted signals, which are frequency shifted relative to one another, can be performed at certain time intervals during the travel by locomotion of the vehicle in a respective transmission process. Consequently, the environment can be continuously captured by reference to one or more virtual antenna arrays. As a result, a reconstruction of the surroundings can be conducted. Based on said surroundings reconstruction or, respectively the reconstructed surroundings, target objects located therein can be captured better or, respectively more precisely, so that the target information such as, by way of example, of a radar target, can be expanded in its information content or, respectively made more comprehensive.

In some embodiments, it is provided that a respective received electrical receive signal, which is allocated to a respective virtual receiving antenna of the virtual antenna array, is mixed with a carrier signal, on which the multiple electrical emitted signals, which are frequency shifted relative to one another, are based. In other words, the electrical receive signal relating to the associated receiving antennas is mixed with the original transmission signal, that is to say the, in particular electrical, carrier signal. On the basis of the carrier signal, which can be provided by a central computing apparatus of the sensor system, the electrical emitted signals, which are frequency shifted relative to one another, can be produced. Again, in other words, the respective receive signal can be mixed by multiplying by the original transmission signal, that is to say the carrier signal. Consequently, a corresponding mixed signal, such as a beat signal, which is needed for the calculation of the virtual antenna array and in particular for the surroundings reconstruction, can be produced here.

In some embodiments, it is provided that a distance spectrum is determined for each virtual receiving antenna on the basis of the receive signal belonging to the respective receiving antenna and mixed with the carrier signal. With said distance spectrum, which can also be described as “range spectrum”, an item of distance information can be generated or, respectively calculated for a respective virtual receiving antenna on the basis of the mixed receive signal. In particular, a respective distance spectrum can be produced for each virtual receiving antenna. Consequently, corresponding distance information with respect to a respective virtual receiving antenna can be provided here.

In some embodiments, it is provided that a respective distance spectrum of a respective virtual receiving antenna is broken down into partial spectrums depending on an emitted electrical emitted signal corresponding to the receive signal and on the transmitting antenna emitting said electrical emitted signal. Consequently, the distance spectrum can be broken down as a function of the corresponding real transmitting antenna. Consequently, a selection is effected here on the basis of the real transmitting antenna and, in particular, the frequency swings of the respective transmitting antenna. This is based on the fact that the transmitting antennas emit the electrical emitted signals, which are frequency shifted relative to one another, so that a respective signal is emitted between two transmitting antennas, which experiences or, respectively has a frequency swing compared to the others. Consequently, a selection of a frequency spectrum of each virtual receiving antenna can be performed on the basis of the respective real transmitting antenna which has emitted the emitted signal corresponding to said virtual receiving antenna. This is in particular beneficial for the surroundings reconstruction and in particular for a three-dimensional surroundings modulation.

In some embodiments, it is provided that the partial spectrums of a respective virtual receiving antenna are projected onto a virtual spatial grid model relating to the surroundings reconstruction, with which the surroundings can be modeled three-dimensionally, as a function of the transmitting antenna corresponding to a respective partial spectrum of the partial spectrums. In other words, a projection of the partial spectrums of a respective virtual receiving antenna onto a spatial grid model can be performed here. For example, a position can be fixed as a starting point regarding a respective transmission process. Said position can in turn be used as a reference for the generation of the virtual spatial grid model. In other words, a virtual or, respectively software modulation or, respectively reconstruction of the surroundings can be conducted with the aid of the grid model. Consequently, target objects can be projected by the system into the spatial grid model by reference to the received receive signals and the corresponding partial spectrums, which can have distance information with respect to the target object.

A spatial extent of the target object can be characterized or, respectively provided by reference to the different partial spectrums. This is in particular beneficial for the determination of the target information, since more comprehensive information with respect to the surroundings and in particular the target object or multiple target objects can be determined as a result. For example, a projection of the partial spectrums of each virtual receiving antenna onto a discrete three-dimensional volume grid, such as the virtual spatial grid model, can be performed as a function of the transmitting antenna corresponding to the respective partial spectrum. This can be used for the surroundings reconstruction of the surroundings. In some embodiments, it is provided that the virtual spatial grid model is subdivided into multiple volume pixels, wherein a respective partial spectrum of the partial spectrums of a respective virtual receiving antenna is assigned to one volume pixel of the multiple volume pixels, on the basis of a relationship between the corresponding transmitting antenna and the virtual spatial grid model. A respective volume pixel can be provided or, respectively filled with information by reference to the respective partial spectrums which include distance information. In other words, each volume pixel of the grid model contains corresponding information, so that corresponding information with respect to the target object can in turn be determined, as a result.

For example, the grid model can have a square configuration, so that the respective volume pixels can in turn have a cuboidal configuration. Depending on the existing grid model, in particular, depending on which surroundings are involved, any number of volume pixels can be combined in order to generate the grid model. Consequently, as a function of the virtual antenna array, corresponding information with respect to the surroundings capturing and, in particular, the target direction can be provided to at least some of the volume pixels.

In some embodiments, it is provided that a phase compensation filtering for compensating for a phase position of the respective partial spectrum in the virtual spatial grid model is performed for a respective partial spectrum, wherein the phase compensation filtering of a respective partial spectrum is performed on the basis of the transmitting antenna corresponding to the respective partial spectrum, the virtual receiving antenna of the respective partial spectrum and a frequency of the electrical emitted signal emitted by the transmitting antenna corresponding to the respective partial spectrum. Consequently, a respective partial spectrum can be filtered so that a compensation of a respective phase position or, respectively phase can be performed. In this case, the transmitting antenna corresponding to the partial spectrum, the virtual receiving antenna of the partial spectrum as well as the frequency of the emitted electrical emitted signal of the corresponding transmitting antenna can be taken into account for the filtering. Most notably, a distance-related phase position of the partial spectrum projected onto the grid model can be compensated for by the phase compensation filtering. As a result, the surroundings modelling or, respectively the surroundings reconstruction can be performed better.

In some embodiments, it is provided that the individual partial spectrums of a respective receiving antenna, in which the phase compensation filtering was performed, are integrated. Consequently, an integration of the filtered projections of all partial spectrums is effected. As a result, a filtered data structure, which corresponds, for example, to a measuring position and the spatial grid model or, respectively grid model at this measuring position, can be allocated to a respective receiving antenna, for example.

A further aspect of the teachings herein relates to a sensor system having multiple transmitting antennas, multiple receiving antennas and one electronic computing apparatus, wherein the sensor system is designed to perform or, respectively carry out a method according to the teachings herein or an embodiment thereof.

Consequently, the method indicated at the outset can be carried out with the sensor system just described.

A surroundings reconstruction, in particular, a three-dimensional surroundings reconstruction, of the surroundings of the sensor system can, for example, be effected with the aid of the sensor system. Most notably, a construction of a synthetic aperture and reconstruction of the received signals can be effected by a virtual antenna array for the reconstruction of the surroundings.

In particular, a frequency conversion of a terahertz carrier signal into the gigahertz frequency range can be performed with the aid of the sensor system after optical signal transmission and reception of gigahertz signals with modulation on the terahertz carrier signal, and vice versa.

In some embodiments, the proposed sensor system can be used in motor vehicles. In some embodiments, the sensor system can be deployed, for example, in at least partially autonomously operated motor vehicles, in particular in fully autonomously operated motor vehicles. Secure sensing of the environment, which can be achieved by the sensor system, is beneficial for such an automated driving function. The environment or, respectively the surroundings can be captured by means of sensors such as radar, lidar and camera. These could be examples of the area of application of the sensor system. A 360-degree three-dimensional capturing of the surroundings in its entirety can be performed by the sensor system so that all of the static and dynamic objects can be captured.

The environment relating to the lateral regions of a vehicle can be captured, in an improved manner, for example, with the sensor system.

The sensor system can be utilized as an alternative to lidar, since lidar in particular plays a major role in the redundant, robust capturing of the environment, since this type of sensor can be deployed more precisely in the capturing of the environment, the measurement of distances and angles, and can also be deployed for classification.

In some embodiments, the sensor system can be deployed, for example, in the case of at least partially autonomously operated motor vehicles, but in particular also in the case of fully autonomously operated motor vehicles. However, sensing the environment reliably is indispensable in order to make possible such an automated driving function. The environment or, respectively the surroundings is/are captured with the aid of sensors such as radar, lidar, or camera. A 360-degree three-dimensional capturing of the surroundings in their entirety is particularly important so that all of the static and dynamic objects can be captured. The sensor system can be used to this end. Admittedly, these lidar sensors are cost-intensive and complex in their construction. In particular, a 360-degree three-dimensional capturing of the environment is problematic, since either many smaller individual sensors are necessary in order to guarantee this, which, as a general rule, work with many individual light sources and detector elements, or large lidar sensors are installed. Furthermore, lidar sensors are susceptible to weather influences such as rain, fog or direct sunlight. To this end, the sensor system can remedy this.

Radar sensors or, respectively sensor systems have likewise become established in automotive engineering and supply data in all weather conditions in a reliable and fail-safe manner. Even poor visibility conditions such as, for example, rain, fog, snow, dust or darkness hardly influence the sensing reliability thereof. Admittedly, according to the prior art, the resolution thereof has been limited thus far; in particular, series-produced radars which are deployed are merely designed with a resolution of an angle of approximately 2 degrees. In order to meet the requirements for an increased level of automation in automotive engineering with safe driving functions, it is provided that the sensor system supplies three-dimensional images having a high angular resolution in the range of 0.1 degrees and below, having a low sensitivity in terms of interferences from the surroundings thereof. This is not achieved with the conventional radar technology according to the prior art since the resolution of such systems is too low. It is precisely there that the sensor system according to the teachings herein is beneficial.

The sensor system can be designed as a photonic radar sensor device which increases the resolution by co-integrating electronic and photonic components in a single semiconductor chip. The tracking of a FMCW signal as well as the entire signal processing and signal evaluation are performed centrally in the central station. Each transmitting and receiving module has an electronic-photonic co-integrated chip, a so-called EPIC chip. Silicon photonics technology is used for the co-integration. This makes possible the monolithic integration of photonic components, high-frequency electronics and digital electronics together on a chip. The technical innovation of such a system lies in the signal transmission of gigahertz signals by means of the optical carrier signal in the terahertz frequency range. A central station, which can also be described as a central electronic computing apparatus, produces an optical carrier frequency in terahertz. On this, the transmitted signal is modulated at one-eighth of the radar frequency and is transmitted to the antenna chips via the optical fiber. On these, the frequency is multiplied, so that the radar radiation can be output by the antenna chips. The signal detection happens in the reverse process. All of the data are processed on the central station.

However, such an embodiment is complex in the implementation of gigahertz electronics at chip level. In particular, the frequency multiplication which takes place on the chip following detection by a photodiode is technically challenging and poses a high challenge in terms of gigahertz signal production with a high signal-to-noise ratio and the lowest possible jitter. Thus, the gigahertz signal has to be stabilized in an elaborate manner in further steps. Moreover, gigahertz electronics are cost-intensive. Furthermore, high power requirements are placed on the optical carrier, in particular the laser, since a lot of optical power is required in order to produce a highly accurate gigahertz signal, which makes single-phase ring circuits difficult to realize for a radar array having many distributed radar semiconductor chips. Furthermore, two photonic-electronic semiconductor chips are, in particular, required for a respective transmitting and receiving channel, which leads to further costs. The problems just mentioned are solved at least partially, in particular completely, by the sensor system according to the teachings herein.

In some embodiments, the teachings herein utilize the fact that the radiation of the laser apparatus, which can in particular also be designed as a CW laser, is coupled in, by means of an optical interface, in a photonic semiconductor. This can be the optical transmission signal or, respectively a carrier signal of the CW laser.

The production of the FMCW signal as well as the entire signal processing and evaluation are performed by a central station, for example the computing apparatus. Each transmitting and receiving module consists of an electronic-photonic co-integrated chip (so-called “EPIC chip”). Silicon photonics technology is used for the co-integration. This makes possible the monolithic integration of photonic components, high-frequency electronics and digital electronics together a on chip (“electronic-photonic co-integration”). The technical innovation of such a system lies in the signal transmission of GHz signals by means of an optical carrier signal in the THz frequency range. A central station produces an optical carrier frequency (THz). On this, the signal to be transmitted is modulated at ⅛ of the radar frequency and is transmitted via optical fiber to the antenna chips. On these, the frequency is increased eightfold, so that the radar radiation can be output by the antenna chips. The signal detection happens in the reverse process. All of the data are processed on the central station.

The principle of the electronic-photonic co-integration in a chip, with silicon-on-insulator regions for the photonic components and bulk silicon regions for the electronic circuits is a globally unique technology. In particular at high data rates, a high signal quality with low parasitic interference can be realized therewith. The linking of the RF circuits for the radar antennas, including frequency multipliers, to the optical transceiver can be implemented without additional wire or flip chip bonding. In addition, chips can already be optically and electrically tested at wafer level, as a result of which a high yield can be achieved in the further modular construction. With this technology, extremely compact form factors can be realized and, associated therewith, a high relevance for the application of optical technologies on the basis of silicon photonics in the automotive industry.

The obstacle to the productive deployment of optical fibers lies in the lack of scalability of previously available technologies. This scalability to large volumes is made possible by the technology for highly integrated production of electronic-photonic integrated circuits. The result is a significant cost reduction in construction technology and a more efficient cost structure. From the development of data center solutions, there exist comprehensive libraries for electronic and photonic components for data transmission at high bandwidths, to which recourse is had in the project.

For example, the sensor system can be configured, in particular, for capturing the environment, with:
In particular, an optical apparatus for producing an optical carrier signal, a transmitting apparatus which has multiple transmitting units, wherein:
In particular, the transmitting apparatus is designed to emit electrical emitted signals which are based on the optical carrier signal, having:
In particular, a first transmission path of the transmitting apparatus, which is designed to provide a first electrical emitted signal which is based on the optical carrier signal to a first transmitting unit of the multiple transmitting units, which is arranged on the first transmission path,
In particular, at least one second transmission path of the transmitting apparatus, which is different to the first transmission path, which second transmission path is designed to produce a second electrical emitted signal which is based on the optical carrier signal, and to provide it to a second transmitting unit of the multiple transmitting units, which is arranged on the second transmission path, wherein
In particular, the transmitting apparatus is designed to produce the second electrical emitted signal such that the second electrical emitted signal has a different second frequency compared to a first t frequency of the first electrical emitted signal, and
In particular, the transmitting apparatus is designed to emit the first electrical emitted signal with the first transmitting unit and the second electrical emitted signal with the second transmitting unit simultaneously in a transmission process.

A further aspect of the teachings herein relate to a vehicle having a sensor system according to the preceding aspect or one or more embodiments discussed herein.

For example, the vehicle can be a manually operated vehicle, a partially autonomously operated vehicle or a fully autonomously operated vehicle. In other words, the vehicle can be a highly automated vehicle.

For example, the vehicle can be a motor vehicle such as a passenger car or truck.

It can, for example, be provided that the sensor system has a real antenna array which, in turn, has multiple antenna elements such as the transmitting and receiving antennas which are arranged on the vehicle in a distributed manner and spaced apart from one another. For example, these can be arranged in the region of a B-pillar of the vehicle. Consequently, the surroundings of the vehicle can be captured as efficiently as possible. Thanks to the distributed arrangement of the individual antenna elements on the vehicle, a 360-degree capturing of the environment can in particular be performed.

For example, the antenna elements of the antenna array can be designed in a “sparse array” configuration. In particular, the antenna elements of the antenna array can be arranged on the vehicle in a sparsely populated or poorly populated configuration.

In the embodiments described herein, the described components of the embodiments each represent individual features that are to be considered independent of one another, in the combination as shown or described, and in combinations other than shown or described. In addition, the described embodiments can also be supplemented by features other than those described. Embodiments of individual aspects are to be regarded as embodiments of other aspects. In particular, the respective embodiments of individual aspects can be regarded as exemplary embodiments of all the other aspects. This applies equally in reverse.

Beneficial configurations of the method or, respectively of the methods are to be regarded as beneficial configurations of the sensor system and of the vehicle. The sensor system as well as the vehicle have objective features which make it possible for the method or a beneficial configuration thereof to be performed.

For application cases or application situations which can occur in the case of the method and which are not explicitly described here, it can be provided that an error message and/or a prompt to enter user feedback is/are issued according to the method and/or a standard setting and/or a predetermined initial state is/are set.

The disclosure also includes embodiments of the sensor system according to the teachings herein and the vehicle according to the teachings herein, which have features as they have already been described in connection with the embodiments of the method. For this reason, the corresponding embodiments of the sensor system and of the vehicle are not described once again here.

The teachings herein also comprise the combinations of the features of the embodiments described.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS. The FIGS. are schematic and not necessarily to scale.

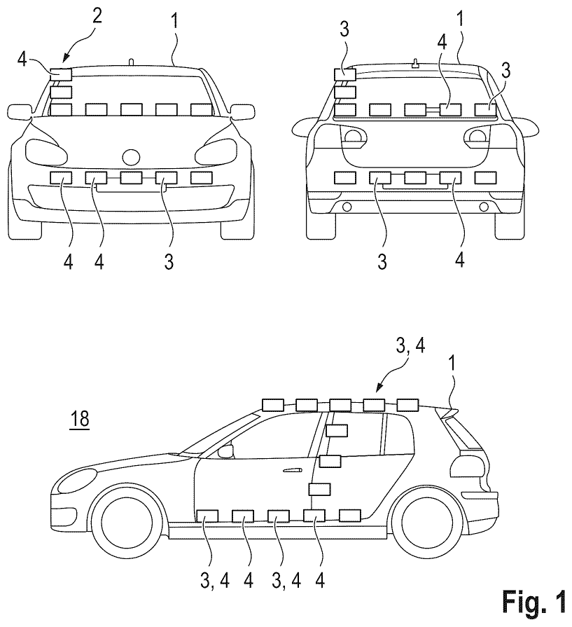

FIG. 1 shows various schematic views (front view, rear view, side view) of a vehicle 1 which can be a motor vehicle. The vehicle 1 includes, for example, a sensor system 2.

The sensor system 2 can, for example, be a radar system or an environment sensor system of the vehicle 1. To this end, the sensor system 2 can be communicatively networked, for example, with one or more driver assistance systems or other vehicle systems. For example, the sensor system 2 can be a radar sensor or a lidar sensor or another type of sensor, in particular for vehicles. In addition to the deployment of the sensor system 2 in the vehicle 1, it can likewise be deployed in systems external to the vehicle.

The sensor system 2 has at least one antenna array or multiple antenna arrays, for example. The antenna array can, in turn, be designed from a plurality of antenna elements such as multiple transmitting antennas 3 and multiple receiving antennas 4. The antenna elements can be arranged on the vehicle 1 in a distributed manner and spaced apart from one another, in particular for the 360-degree capturing of the environment.

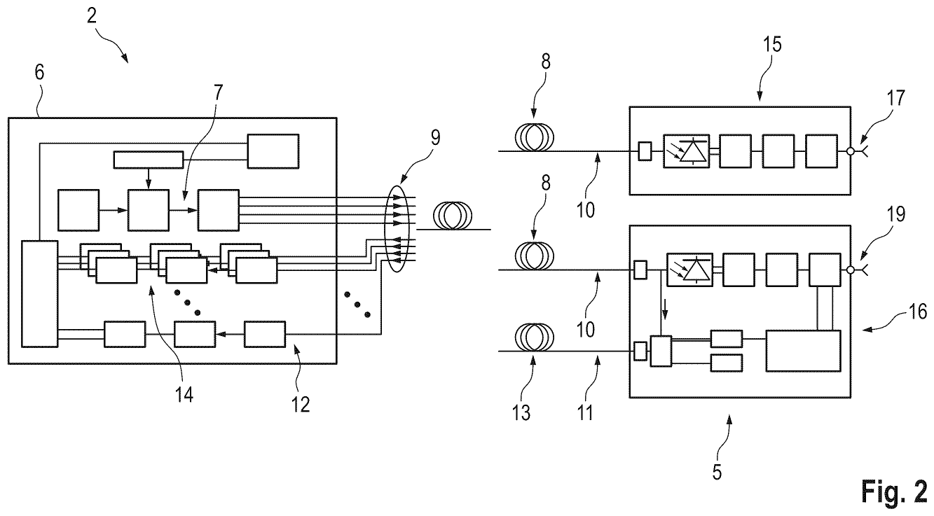

FIG. 2 shows a conceivable embodiment of the sensor system 2. The sensor system 2 can have at least one radar sensor device 5 and a central electronic computing apparatus 6. The radar sensor device 5 and the central electronic computing apparatus 6 can, for example, be separate and physically isolated units. The radar sensor device 5 can, for example, have the at least one antenna array 3. Otherwise, the antenna array can function as a radar sensor device 5.

The central electronic computing apparatus 6 can be a central unit. For example, the central electronic computing apparatus 6 can produce an electrical control signal, with which a laser apparatus 7 can be actuated or, respectively controlled. The laser apparatus 7 can, for example, be a CW laser. An optical transmission signal or, respectively a carrier signal 8 can be produced with the aid of the laser apparatus 7. The optical transmission signal 8 can in particular be described as an optical carrier signal in the terahertz frequency range. The central electronic computing apparatus 6 can, for example, produce the optical carrier frequency. On this optical carrier frequency, the signal to be transmitted is modulated at one-eighth of a radar frequency and is, for example, transmitted to the radar sensor device 5. In this way, an eightfold increase in frequency can take place. Signals in the gigahertz frequency range can, in turn, be received and transmitted to the central electronic computing apparatus 6 with the aid of the radar sensor device 5.

The central electronic computing apparatus 6 can, for example, be coupled in each case via at least one glass fiber 9 to an optical input 10 and an optical output 11 of the radar sensor device 5. Consequently, a bidirectional signal transmission can be effected between the central electronic computing apparatus 6 and the radar sensor device 5.

The central electronic computing apparatus 6 can, for example, be described as an electronic evaluation unit.

Moreover, the central electronic computing apparatus 6 can have an optical receiving unit 12 which is adapted to receive an optical output signal 13 which is provided with the optical output 11 of the radar sensor device 5. Consequently, the central electronic computing apparatus 6 can be coupled to the radar sensor device 5 via optical fiber or electronic interface such as, by way of example, Ethernet. In particular, multiple radar sensor devices or antenna arrays can be coupled to the central electronic computing apparatus 6. For example, the central electronic computing apparatus 6 can have a processing unit 14 or, respectively a computing unit with which the received optical output signal can be processed. Consequently, a signal acquisition and a subsequent data processing of the received output signal 11 can be performed.

In particular, the central electronic computing apparatus 6 can have or, respectively provide all of the necessary control signals, data processing signals, modules and interfaces.

In addition to the optical input 10 and the optical output 11, the radar sensor device 5 can, for example, have at least one transmitting apparatus 15, which can in each case be one transmitting antenna of the multiple transmitting antennas 3, and at least one receiving apparatus 16, which can in each case be one receiving antenna of the multiple receiving antennas 4. Consequently, the radar sensor device 5 has a receiving module and/or transmitting module. In particular, the transmitting apparatus 15 and the receiving apparatus 16 can be integrated on one and the same chip. It is likewise conceivable that these are located on different semiconductor chips.

An electrical radar emitted signal 17, which is based on the optical transmission signal 8, can be emitted into the surroundings 18 of the vehicle 1 with the aid of the transmitting apparatus 15. Consequently, a corresponding radar signal 17 can be emitted as a function of the optical transmission signal 8. If this signal 17 is now reflected in the surroundings 18 by objects such as, for example, road users, roads, trees or other objects, an electrical receive signal 19 corresponding to the electrical radar emitted signal 17 and reflected in the surroundings 18 can be received.

The transmitting apparatus 15 can, for example, have at least one antenna or, respectively one antenna unit or multiple antennas for the emission.

The radar emitted signal 17 or, respectively electrical emitted signal emitted and the receive signal 19 received can, for example, be in the terahertz frequency range or gigahertz frequency range. Consequently, a frequency conversion of a terahertz carrier signal, in particular of a transmission signal 8, into the gigahertz frequency range for emission can be performed with the aid of the sensor system 2. Conversely, the reception of gigahertz signals can be performed with modulation on the terahertz carrier signal. For example, the transmitting apparatus 15 can have at least one grating coupler and a photodiode for the emission. The receiving apparatus 16 can, for example, have two jitter couplers, a photodiode and a modulator for the reception.

The signal can be modulated at ⅛ of the radar frequency and transmitted via optical fiber to the antenna chips or, respectively antenna elements with the sensor system 2. On these, the frequency is specifically increased eightfold, so that the radar radiation can be output by the antenna chips. The signal detection optionally happens in the reverse process. All of the data can be processed on the central station.

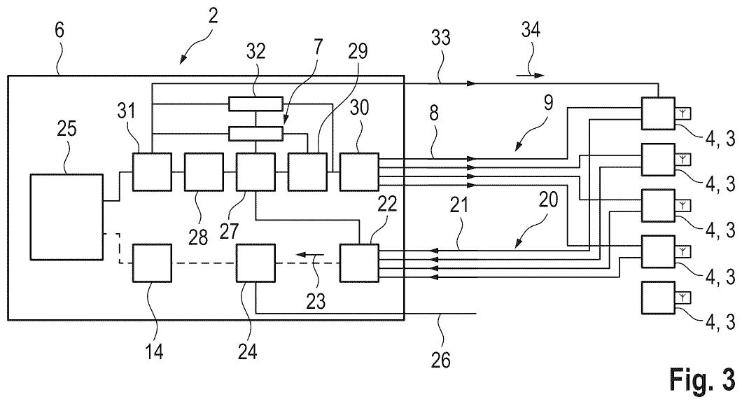

FIG. 3 shows a further embodiment of the sensor system 2. Here, the sensor system likewise has the computing apparatus 6 which can have another configuration or, respectively equipment in this embodiment.

The sensor system 2 specifically has multiple transmitting/receiving units such as, for example, the transmitting and receiving antennas 3, 4, which can, e.g., be arranged in a distributed manner on the vehicle 1, in particular for capturing the environment.

The transmitting/receiving units or, respectively antenna elements can be utilized both for transmitting and for emitting or, respectively for receiving signals. Consequently, the transmitting/receiving units are combined units for emitting and for receiving signals.

In particular, such a transmitting/receiving unit can be described as a transmitting and receiving module. This can be designed from an electronic-photonic co-integrated chip (so-called “EPIC chip”). The computing apparatus 6, which can be described as a central unit, can likewise be designed from an electronic-photonic co-integrated chip. In particular, the computing apparatus 6 is a physically and/or spatially separate unit from the transmitting/receiving units.

The computing apparatus 6 can, for example, have an optical unit or, respectively the laser apparatus 7 or a laser. In particular, the optical unit 7 can be designed as an optical source or as a CW laser. The optical transmission signal 8 or, respectively a carrier signal can be produced and consequently provided with the aid of the optical unit. The optical transmission signal 8 can for example be designed as an optical carrier signal in the terahertz frequency range. The computing apparatus 6 can, e.g., produce the optical carrier frequency. At this optical carrier frequency, the signal to be transmitted can be modulated at one-eighth of a radar frequency and transmitted, e.g., to the transmitting/receiving units. In this way, the frequency can be multiplied. Signals in the gigahertz frequency range can, in turn, be received with the aid of the transmitting/receiving units.

The computing apparatus 6 can, for example, be connected to a respective transmitting/receiving unit via glass fiber 9, as an optical transmission path. Signals, in particular optical signals, can be transmitted via the glass fiber 9 from the computing apparatus 6 to the individual transmitting/receiving units. In order to, in turn, be able to send received signals from the transmitting/receiving units back to the computing apparatus 6 for evaluation or, respectively signal processing, a respective transmitting/receiving unit can be optically coupled to the computing apparatus 6 via an optical return channel 20.

The electrical emitted signal 17 can be emitted, in particular into the surroundings 18, with at least one transmitting/receiving unit. Likewise, an electrical receive signal 19 corresponding to the electrical emitted signal 17 can, in turn, be received with the transmitting/receiving unit. For example, the emitted signal 17 can be reflected by an object in the surroundings 18 of the vehicle 1 and, consequently, received as an electrical receive signal 19. The receive signal 19, which can, e.g., be described as a radar signal, can be transferred or, respectively transmitted to the computing apparatus 6 for evaluation or, respectively signal processing. To this end, the electrical receive signal can be converted by means of the transmitting/receiving unit into an optical receive signal 21. For example, this can be transmitted via the return channel 9 to the computing apparatus 4. The optical receive signal 21 can, in turn, be converted into an electrical signal 23 by means of an optical-to-electrical converter unit 22 or, respectively detector unit of the computing apparatus 6. The unit 22 can, e.g., be used for optical detection. To this end, the conversion can, e.g., be effected by homodyne detection or heterodyne detection. Moreover, the unit 22 can conduct a phase measurement and/or a phase length measurement.

A digitization can, in turn, be subsequently effected by means of a digital interface 24. In this case, an analog-to-digital conversion can most notably be effected. To this end, the digital interface 24 can have an analog-to-digital converter. A processing unit 14 can subsequently be arranged. A signal processing, in particular in the case of a “low-level signal”, can, e.g., be utilized with this. For example, a Fast Fourier Transform (“FFT”) can be used to this end. The digitized, processed electrical signal 23 can subsequently be made available to a CPU 25 of the computing apparatus 6. In this case, an item of radar information or, respectively environmental information contained in the electrical signal 23, can in particular be evaluated or, respectively processed. Moreover, an electrical return channel 26 can be provided, which provides a back coupling from at least one of the transmitting/receiving units to the computing apparatus 6 and in particular to the digital interface 24.

In order to be able to conduct the capturing of the environment or, respectively detection of the sensor system 2 in the most stable and low-noise manner possible, the optical transmission signal 8 can be adjusted by means of a frequency synthesis or, respectively gigahertz frequency synthesis. To this end, the computing apparatus 6 can have a synthesis unit 27. To this end, the optical transmission signal 8 can be fed or, respectively transmitted to the synthesis unit 27. For example, before the optical transmission signal 8 is made available to the synthesis unit 27, a modulation can be conducted. To this end, a modulator or, respectively a modulation unit 28 can, e.g., be provided. This can be designed, e.g., as an arbitrary generator or arbitrary waveform generator (AWG). After the synthesis unit 27, e.g., an optical control unit 29 as well as an optical switch or, respectively distributor 30 can be provided in the computing apparatus 6 in order to be able to make correspondingly processed signals from the synthesis unit 27 available to the transmitting/receiving units via the glass fiber 9. Moreover, a control unit 31 can be controlled by the evaluation unit 25 in order to be able to monitor or, respectively control the production of the optical transmission signal in particular. Moreover, a control unit or, respectively a feedback loop 32 can be provided.

Moreover, the computing apparatus 6 is electrically connected to the transmitting/receiving units by means of an electrical transmission path 33. An electrical control signal 34 can be transmitted via this electrical transmission path 33 for controlling or, respectively for actuating the transmitting/receiving units or, respectively antenna elements 4.

In particular, the computing apparatus 6 serves to produce an optical carrier signal, the optical transmission signal 8, and to feed this into a gigahertz frequency synthesis unit, e.g. the synthesis unit 27. The synthesized gigahertz signal can be transmitted to the transmitting/receiving units in the optical spectral range via fiber, that is to say, the glass fiber 9, so that, e.g., a 77 gigahertz signal can be output or, respectively emitted by transmitting/receiving units. The signal detection can, in turn, be effected in the reverse process. All of the data can be processed in the computing apparatus 6.

In the representation in FIG. 3, the optical carrier signal 8 can be described as an optically frequency-modulated carrier signal. This can be fed in a gigahertz frequency synthesis unit, such as in the synthesis unit 27, and the synthesized gigahertz signal can be forwarded to the transmitting apparatus 15 in the optical spectral range in order to be output, by way of example, as a 77 GHz signal.

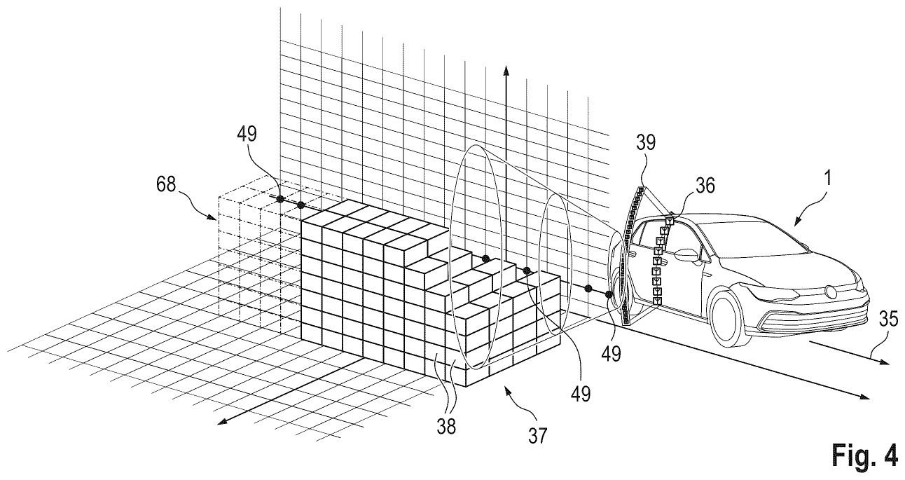

An embodiment is explained in FIG. 4. In particular, the present teachings come into effect when a spatial extension of objects in the vehicle environment of the vehicle 1 is to be captured. In other words, the vehicle 1 is in movement and covers, for example, a trajectory 35.

For example, multiple transmitting antennas 3 and receiving antennas 4 can be arranged as a real antenna array 36 in the region of the B-pillar of the vehicle 1, so that the environment can be captured on the side of the vehicle 1. Moreover, the sensor system 2 can have further transmitting and receiving antennas which can in turn be arranged in a distributed manner on the vehicle 1, as already explained. In this case, extended structures in the vehicle environment can now be reliably captured, and the height profiles of said structures can be estimated, thanks to the teachings herein. To this end, a surroundings reconstruction, in particular a three-dimensional surroundings the reconstruction, of surroundings 18 is performed. A virtual spatial grid model 37 is used here. As shown in FIG. 4 as an example, said virtual grid model 37 can consist of rectangular or cuboidal volume pixels.

Since the real antenna array 36 can be sparsely populated due to cost and/or space reasons, a virtual antenna array 39 is generated for the production or, respectively generation of the grid model 37 and, in particular, for the surroundings reconstruction.

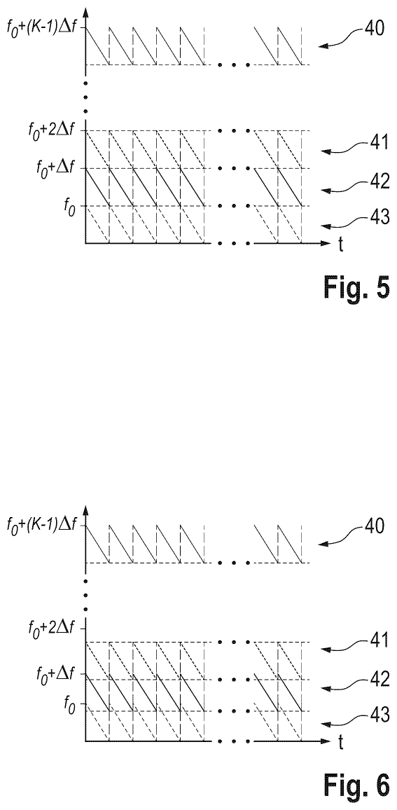

In the following figures, embodiments are explained regarding how the surroundings reconstruction can be effected, so that target information of target objects in the surroundings 18 can be determined on the basis of the surroundings reconstruction. Various frequency signal curves of electrical emitted signals 40 to 43 are shown in FIG. 5.

A simultaneous or, respectively concurrent transmission or, respectively emission of the electrical emitted signals into the surroundings 18 is effected for the computer-based generation of the virtual antenna array 39. Said electrical emitted signals can in turn be emitted, over time, with the transmitting antennas 3, in particular the transmitting antennas of the real antenna array 36. As indicated in FIG. 5 as an example, each transmitting antenna 3 emits the electrical emitted signals 40 to 43 in one transmission process, or, respectively transmission cycle.

As shown in FIG. 5, said electrical emitted signals 40 to 43 are frequency shifted relative to one another. Most notably, said electrical emitted signals 40 to 43 can be described as frequency-modulated signals; in particular, the electrical emitted signals 40 to 43 can be based on the optical signal 8. For example, it can be shown with FIG. 5 that each transmit signal, that is to say the signals 40 to 43, can be provided as a sharp sequence for each frequency modulation. Each transmitting antenna 3 emits a frequency-modulated signal, the frequency of which differs by the frequency swing Δf with respect to the transmitting frequencies of the other transmitting antennas.

For example, the following can be defined as the transmitter signal in terms of the electrical emitted signals 40 to 43:

$${s}_{T} ( t ) = cos ( 2 πΦ ( t ) )$$

For a respective transmitting antenna 3, the respective phase modulation can be mathematically described with the following equations:

$$\begin{matrix}Φ ( t ) = {f}_{0} t + \frac{1}{2} α {t}^{2} \\ {Φ}_{1} ( t ) = ( {f}_{0} + Δ f ) t + \frac{1}{2} α {t}^{2} \\ {Φ}_{2} ( t ) = ( {f}_{0} + 2 Δ f ) t + \frac{1}{2} α {t}^{2} \\ {Φ}_{K - 1} ( t ) = ( {f}_{0} + ( K - 1 ) Δ f ) t + \frac{1}{2} α {t}^{2}\end{matrix}$$

A gradient of the frequency ramp can be determined with the following formula:

$$α = \frac{Δ f}{{T}_{Ch}}$$

The previously used variables are described below:
f₀ Carrier frequency
Δf Frequency swing
α Gradient of the frequency ramp
T_{CH} Modulation duration of a chirp
s_{T}(t) Transmit signal
Φ_{K-1}(t) Phase modulation of a respective transmitting antenna

Another possibility in terms of the production or, respectively provision of the electrical emitted signals 40 to 43 is shown in FIG. 6. Contrary to the configuration in FIG. 5, the electrical emitted signals 40 to 43 can be configured here with overlapping modulation regions. This approach makes it possible to cover multiple overlapping frequency bands and to produce greater virtual appliances. The other explanations regarding FIG. 5 apply analogously here.

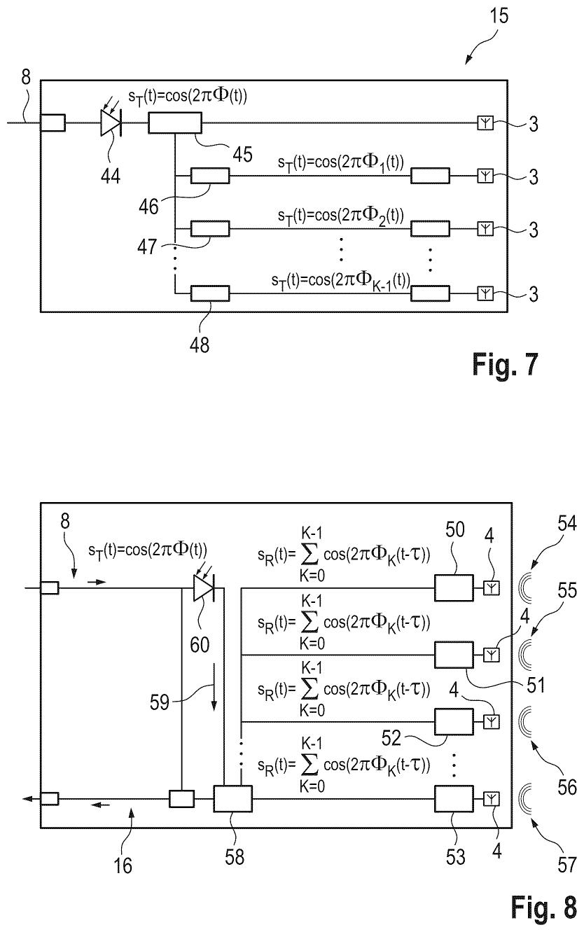

It is, for example, shown in FIG. 7 how the transmitting apparatus 15, to which the respective transmitting antennas 3 can belong, can be configured. Any number of transmitting antennas 3 can belong to the transmitting apparatus 15. As now shown in this representation, the transmitting antennas 3 can be arranged on one chip or, respectively on one circuit in terms of the transmitting apparatus 15. It is likewise conceivable that the transmitting antennas 3 are separate units and, consequently, arranged as separate electrical circuits.

The optical carrier signal 8 can, for example, be provided and transferred or, respectively converted in an electrical or, respectively electronic region by means of a photodiode 44. Consequently, a electrical corresponding or, respectively electronic signal is provided here which can, in turn, be used as a basic transmit signal for the modulation of the individual electrical emitted signals 40 to 43. This basic electrical transmit signal can, for example, be amplified optionally by means of an amplifier or, respectively electronic amplifier 45.

Each transmitting antenna 3 can be allocated, for example, to a respective transmission path, so that a corresponding electrical emitted signal 40 to 43 can be provided for each transmission path. To this end, frequency conversion units 46 to 48 can, in turn, be provided in each transmission path and, consequently, upstream of a respective transmitting antenna 3. The optical carrier signal 8 converted into an electrical range for a respective transmitting antenna 3 can be correspondingly frequency modulated with a respective frequency conversion unit 46 to 48 or, respectively a respective frequency converter, so that each transmitting antenna 3 emits such a signal, which is frequency shifted compared to the other signals. Consequently, the frequency swing, by which the respective electrical emitted signal 40 to 43 differs at each transmitting antenna 3, can be produced in a respective transmission path by means of a respective frequency conversion unit 46 to 48 depending on the optical carrier signal 8.

In particular, the electrical emitted signals 40 to 43, which are frequency shifted relative to one another, can be emitted for each transmission process by all of the transmitting antennas 3, in particular the transmitting antennas of the real antenna array 36.

As already mentioned, the vehicle 1 can be a vehicle moving along a trajectory 35. Consequently, a transmission process can be performed in each case here at certain measuring positions 49 (cf. FIG. 4). Consequently, a transmission process can be performed in each case in relation to the different measuring positions 49, in which electrical emitted signals 40 to 43, which are frequency shifted relative to one another, can be emitted, in particular by all of the transmitting antennas 3.

A further configuration of the receiving apparatus 16 is now shown in FIG. 8. Here, similarly to the transmitting apparatus 15, all of the receiving elements 4 can either be arranged on one chip or, respectively, an integrated circuit (IC), or each receiving antenna 4 has, in turn, a chip of its own. In this case, a respective reception path can, in turn, be allocated to a respective receiving antenna 4. An electrical amplifier can, in turn, be arranged for each reception path and, consequently, after a respective receiving antenna 4. Each incoming receive signal 54 to 57 can, for example, be mathematically modulated as a superposition of the time-delayed and frequency-divergent electrical emitted signals 40 to 43. In this case, the frequency-modulated original signal, in particular the optical carrier signal 8, can be used as the reference signal of the mixing process. This process can be performed, for example, by means of an electronic unit 85 which can be a “mixer”. To this end, the respective receive signals 54 to 57 can be supplied to the unit 58 as shown in FIG. 8 as an example. Additionally, a carrier signal 59 can in turn be supplied to the unit 58. The carrier signal 59 can be converted in particular by a photodiode 60 from the optical carrier signal 8. Subsequently, a corresponding signal can be subsequently transmitted by the unit 58 to the computing apparatus 6, for example.

For example, the beat signal considered for the further processing can be produced by an I/Q modulation (not shown here). In other words, such a beat signal can be produced in terms of each receive signal 54 to 57.

For example, such a beat signal can be defined as follows:

$${s}_{B} ( t , l ) = {\sum }_{k = 0}^{K - 1} exp ( - 2 π j ( k Δ f + α τ ( k , l ) ) t - ( {f}_{0} + k Δ f ) τ ( k , l ) )$$

To this end, the following definitions are to be understood with the following variables:
τ Propagation delay
t Index receiving antenna
k Index transmitting antenna
K Number of transmitting antennas
s_{B}(t,l) Beat signal

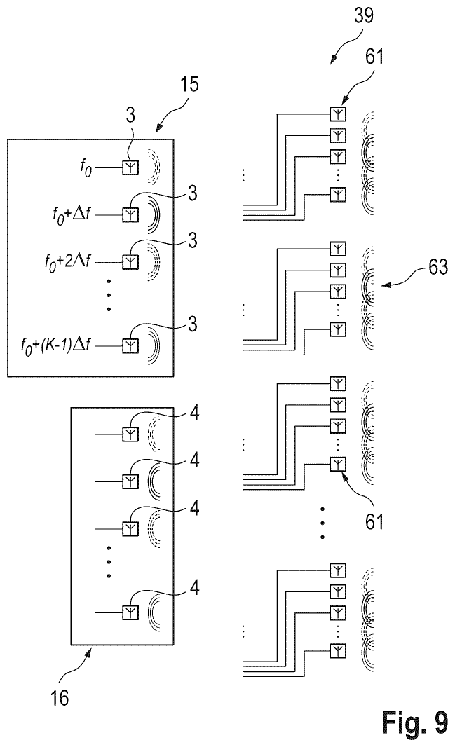

It is now schematically shown in the following FIG. 9 how, on the basis of the electrical emitted signals 40 to 43 emitted over time, for example by means of the transmitting apparatus 15, and the received receive signals 54 to 57, for example by means of the receiving apparatus 16, the virtual antenna array 39 is generated or, respectively produced. Most notably, the virtual antenna array 39 can be designed on the basis of the antenna manifold of the underlying physical or, respectively real transmitting/receiving antennas 3, 4. For example, the virtual antenna array 39 can have a plurality of virtual receiving antennas 61. Most notably, the virtual antenna array 39 offers the benefit that it has a greater number of virtual receiving antennas 61 compared to the real antenna array 36. The number of the virtual receiving antennas 61 is at least many times greater than the real receiving antennas 4.

Moreover, it is, for example, shown in FIG. 9 that the virtual antenna array 39 can be structured as a logical group which is characterized by the physical antenna positions of a receiving antenna 4 and all of the transmitting antennas 3. Most notably, the virtual antenna array 39 can be produced on the basis of the received electrical signals 54 to 57, the real antenna positions of the transmitting antennas 3 and the real antenna positions of the receiving antennas 4.

The underlying receive signal of a respective virtual receiving antenna 61 can, for example, correspond to the beat signal explained in FIG. 8.

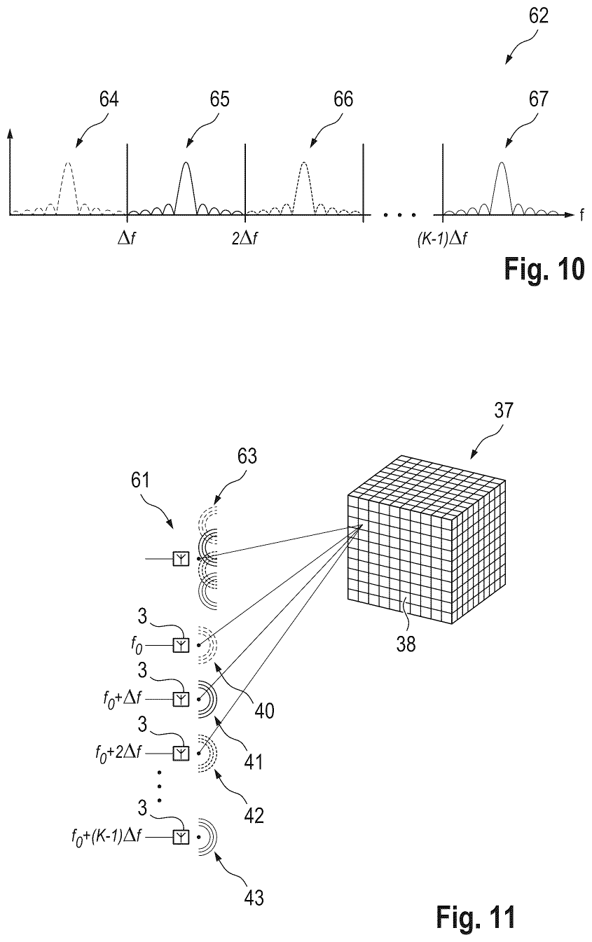

The associated generated distance spectrum 62 or, respectively a range spectrum is shown, for example for a virtual receiving antenna 61, in FIG. 10. This distance spectrum 62 can, for example, be described with the following formula:

$${S}_{B} ( u , l ) = ℱ \{ {s}_{B} ( t , l ) \}$$

The electrical and in particular, mixed receive signals 63 belonging to said virtual receiving antenna 62 can be taken into account for the determination of the distance spectrum 62. Due to the frequency conversion of the optical carrier signal 8 by an integer multiple of the bandwidth chirps, the distance spectrum 62 of the underlying receiving channel or, respectively of the receiving antenna 61 can be separated by the impressed-upon frequency swing.

In other words, as shown in FIG. 10, partial spectrums 64 to 67 can be generated or, respectively, separated. In other words, the distance spectrum 62 is broken down or, respectively, separated into multiple partial spectrums 64 to 67. The partial spectrums can be different spectral ranges of the distance spectrum 62. Most notably, an allocation of output transmit signals, that is to say the emitted signals 40 to 43, to the spectral range within the spectrum of a virtual receive channel can be performed. In other words, various electrical emitted signals 40 to 43 can be received by the respective receiving antenna 4 and, consequently, by the respectively associated virtual receiving antenna 63. These have, in turn, a frequency swing, which is different from one another in each case, so that on the basis thereof the transmit signals 40 to 43 are broken down into partial spectrums in the virtual receiving antenna by reference to the different frequency swings in each case. In other words, each of these partial spectrums 64 to 67 can be selected in terms of the different frequencies or, respectively bandwidths of the emitted signals 40 to 43. For example, the emitted signal 43 corresponding to the partial spectrum 64, the emitted signal 42 corresponding to the partial spectrum 65, the emitted signal 41 corresponding to the partial spectrum 66, and the corresponding emitted signal 40 for the partial spectrum 67, can be taken into account or, respectively considered.

In the following FIG. 11, it is now explained how the distance spectrum 62 of a virtual receiving antenna 61 is to be projected onto a respective volume pixel 38 within the three-dimensional grid model 37 by means of a projection principle. The basis of the projection is, for example, a linear interpolation of the distance spectrum 62 as a function of the time delay which corresponds, due to the distance between the transmitting antenna 3 and the virtual receiving antenna 61, to the volume pixel coordinates in the grid model 37.

In other words, the spectral value of a respective partial spectrum 64 to 67 is projected onto the spatial coordinate within the grid model 37 corresponding to the distance. That is to say, the distance spectrum 62 can have distance information. Most notably, a reference can be established here in the relationship, which can be considered due to the respective measuring positions 49 during a respective transmission process. As shown in FIG. 11 as an example, for the allocation of a respective partial spectrum 64 to 67 to a volume pixel 38, the, in particular relative, position of the respective transmitting antenna 3 can be considered. As shown in FIG. 4 as an example, the vehicle 1 moves along the trajectory 35, and signals can be emitted and accordingly received at the respective measuring positions 49 in relation to the trajectory 35. Consequently, as schematically shown in FIG. 4, a partial region 68 of the filter model 37 can be produced in terms of a respective measuring position 49. If the vehicle 1 now, in turn, continues driving, a sub-region of the space grid 37, can in turn be generated for the next measuring position 49. Consequently, a reconstruction of the surroundings 18 can be performed.

A projection of the spectral value onto a spatial coordinate corresponding to the distance within the grid model can be described with the following equations:

$$\begin{matrix}{S}_{B} ( {u}_{v} , l ) = {S}_{B} ( u , l ) + \frac{{x}_{1} - x}{Δ x} ( {S}_{B} ( u , l ) - {S}_{B} ( u + 1 , l ) ) \\ x = \frac{τ ( k , l )}{{c}_{0}} \\ {x}_{1} = u Δ x \\ τ ( k , l ) = \frac{{‖ {p}_{{T}_{x , k}} - {p}_{H} ‖}_{2} + {‖ {p}_{{T}_{x , l}} - {p}_{H} ‖}_{2}}{{c}_{0}}\end{matrix}$$

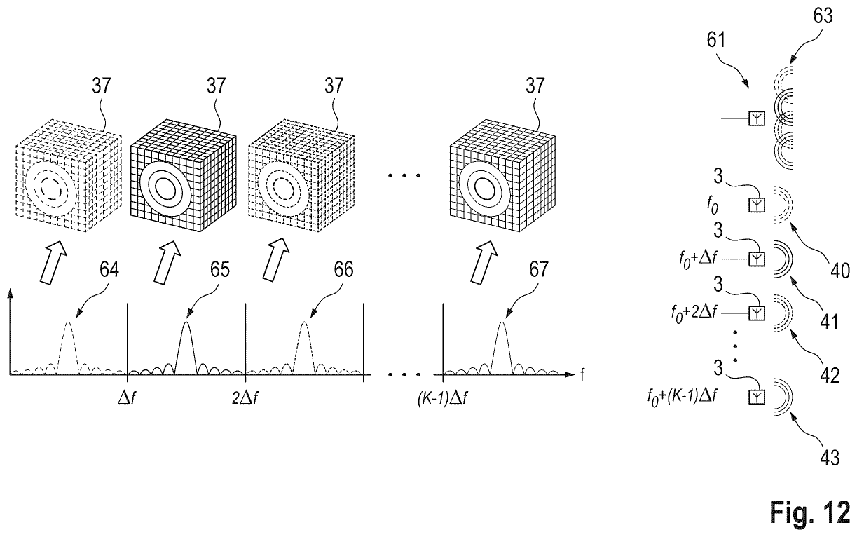

It is now shown, as an example, in FIG. 12 how the respective partial spectrums 64 to 67 can be projected or, respectively instructed or, respectively incorporated into the grid model 37. Consequently, a surroundings modulation or, respectively a surroundings reconstruction can be performed.

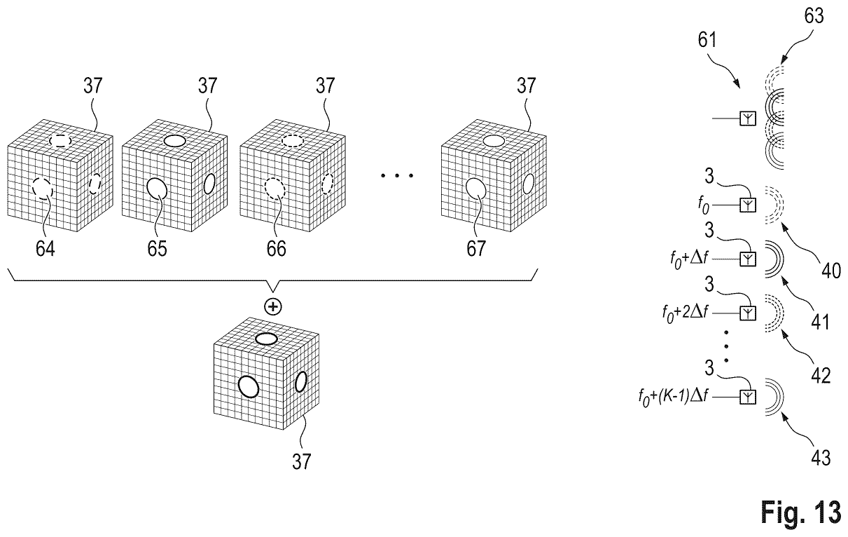

It is now explained in FIG. 13, as an example, how a compensation of the distance-related phase position of the partial spectrum 64 to 67 projected onto the grid model 3 regarding the surroundings modulation can be performed. To this end, a filter process, that is to say, a filtering, can be conducted. Most notably, a phase compensation filtering is effected here. To this end, the partial spectrums 64 to 67 of a respective virtual antenna element 61 can be filtered.

The phase position of the projection can depend on the superposition of the phases which result due to the distance of the transmitting antennas 3 from the volume pixel coordinate and the receiving antenna 4. Accordingly, the filter can take these influencing factors into account for the compensation of this phase position. Additionally, the individual frequency swing of the corresponding transmitting antenna 3 can likewise be included in the consideration. After performing the filtering, the filled projections and, consequently, the filtered partial spectrums 64 to 67 can be integrated.

To this end, a filter function h(l) can, for example, be used to compensate for the phase position of individual partial spectrums, as can be described with the following equations. Influencing factors can be the antenna positions of all of the transmitting antennas 3, the antenna position of the receiving antenna 4 under consideration as well as the transmitting frequency including the transmitting antenna. The running index 1 references the currently considered virtual receiving antenna 61.

$$\begin{matrix}h ( l ) = {\sum }_{k = 0}^{K} exp ( - 2 π j ( {f}_{0} + k Δ f ) τ ( k , l ) ) \\ τ ( k , l ) = \frac{{‖ {p}_{{T}_{x , k}} - {p}_{H} ‖}_{2} + {‖ {p}_{{R}_{x , l}} - {p}_{H} ‖}_{2}}{{c}_{0}}\end{matrix}$$

Consequently, a phase image compensation filtering can be performed with this filter function.

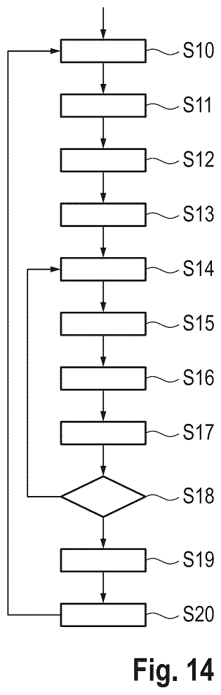

An exemplary procedure in terms of the surroundings, for the construction by, for example, antenna arrays installed on the sides of the vehicle 1, is now explained in FIG. 14.

In an optional step S10, a MIMO method can be applied. This happens by simultaneous transmission of frequency-converted or, respectively frequency-shifted transmit signals such as the electrical emitted signals 40 to 43. Most notably, this step S10 is effected at a measuring position 49. Said measuring position can in turn have the coordinates X, Y, Z.

In a subsequent optional step S11, the corresponding receive signals 54 to 57 can be received after the simultaneous outputting of the electrical emitted signals 40 to 43. Subsequently, the reception of a respective receive signal 54 to 57 can be mixed by multiplying by the carrier signal 59.

In the optional subsequent step S12, a range spectrum or, respectively the distance spectrum 62 can be calculated for each virtual receiving antenna 61.

Subsequently, in an optional step S13, the frequency spectrum or, respectively the distance spectrum 62 can be broken down into the partial spectrums 64 to 67 depending on the frequency swings and allocation of the corresponding transmitting antennas 3.

In a subsequent optional step S14, the partial spectrums 64 to 67 of the virtual receiving antenna 61 can then be projected onto the spatial grid model 37 in relation to the current measuring position 94.

In a subsequent optional step S15, a phase compensation filter for the phase compensation of the projected partial spectrum 64 to 65 can be calculated. In this case, the receiving position of the virtual receiving antenna 61, the position of the corresponding transmitting antenna 3 and the transmission frequency regarding this corresponding transmitting antenna 3 can be taken into account.

In a subsequent step S16, the compensation of the phase position within the spatial grid model 37 can be effected for each partial spectrum 64 to 67.

In a subsequent step S17, an integration of the filtered projections of all of the partial spectrums 64 to 67 can be performed.

In a subsequent step S18, the steps S14 to S17 are effected in each case for all of the virtual receiving antennas 61.

After the partial spectrums 64 to 67 have been projected into the grid model 67 for this measuring position 49 relating to each virtual receiving antenna 61, in an optional step S19, the integration of the filtered projection of all of the virtual receiving antennas 61 can be effected.

Finally, in a next step S20, the steps S10 to S19 can now be effected for the following measuring position 49 along the trajectory 35. In other words, the steps S10 to S19 are effected for a respective measuring position and, consequently, for the respective transmission process.

Below, optional steps describe the disclosure in other words for reconstructing a captured three-dimensional environment by constructing a synthetic aperture and reconstructing the signals received by a virtual antenna array along the trajectory 35 of a vehicle 1:
1. Completely coherent sensor in 3D along the vehicle B-pillar;
2. Simultaneous transmission of frequency-modulated transmit signals (emitted signals 40 to 43) of different frequencies by all transmitting antennas 3;
3. Production of a virtual antennas array 39 by applying the MIMO method;
4. Mixing of the receive signal 54 to 57 of each virtual receive channel (receiving antenna 61) with the original transmit signal (carrier signal 59), which is not subject to any further frequency conversion;
5. Repetition of the transmission process at equidistant intervals for constructing a synthetic aperture;
6. Calculation of the range spectrum 62 for all of the virtual receive channels;
7. Breakdown of the range spectra as a function of the frequency swings of each transmitting antenna 3;
8. Projection of the resulting partial spectrums 64 to 67 of each virtual channel onto a discrete three-dimensional volume grid 37 as a function of the transmitting antenna corresponding to the partial spectrum;
9. Back projection by filtering the association of volume pixels 38 and projected spectral value from range spectrum:
   a. Filter calculation based on measuring position 49 of corresponding transmitting antenna position, transmitting frequency, 3D coordinate of the volume pixel and virtual receiving antenna 61
   b. Application of the filter to phase of the corresponding volume pixel
   c. Storage of the filter value in a data structure equivalent to the three-dimensional spatial grid model for each partial spectrum
10. Integration of the data structures of each partial spectrum, so that a filtered structure, which corresponds to a measuring position and the spatial grid model at this measuring position, can be allocated to each virtual receive channel;
11. Performance of step (7), (8) and (9) for each virtual receive channel;
12. Integration of the data structures of the back-projected three-dimensional space grid models of all of the virtual receive channels. Each measuring position is consequently allocated a spatial grid model, and a data structure which is composed of the sum of the filtered spectral projects on said spatial grid model;
13. Repetition of steps (5) to (11) for each new measuring position;
14. Integration of the amounts at the same spatial grid coordinates across all measuring positions.

In other words, a construction of a synthetic appliance and a reconstruction of the captured surroundings 18 can be effected. To this end, the vehicle 1 can produce a virtual antenna array within a measurement cycle and capture the surroundings 80 laterally to the vehicle direction at equidistant intervals. In other words, a capturing and, subsequently, a signal processing process are effected at a respective measuring position 49. A three-dimensional grid model such as the grid model 37 of the surroundings 18 serves as the basis of the spatial projection of the distance spectrum of received signals and as the basis of the reconstruction of a three-dimensional amplitude map for capturing spatially extended structures. Consequently, an improved capturing of the surroundings, in particular of the spatially extended structures therein, such as target objects, can be effected with the aid of the filled or, respectively information-enhanced grid model 37.

In particular, the transmitting antennas 3 and the receiving antennas 4 can be arranged as miniaturized, photonic co-integrated radar chips in a coherently distributed, thinned-out array 36 along the vehicle's B-pillar. Thanks to a simultaneous transmission of frequency-modulated signals having different frequency swings, the virtual antenna array 39 can subsequently be produced for a respective transmission cycle by means of applying the MIMO method. Subsequently, the measuring positions 49 for constructing a synthetic aperture and reconstructing the surroundings 18 to produce a three-dimensional surroundings map such as the grid model 37 can be effected by performing measurements at spatially equidistant intervals.

### LIST OF REFERENCE NUMERALS

1 Vehicle
2 Sensor system
3 Antenna array
4 Antenna elements
5 Radar sensor device
6 Central electronic computing apparatus
7 Optical apparatus
8 Optical carrier signal
9 Glass fiber
10 Optical input
11 Optical output
12 Receiving unit
13 Output signal
14 Processing unit
15 Transmitting apparatus
16 Receiving apparatus
17 Electrical emitted signal
18 Surroundings
19 Electrical receive signal
20 Return channel
21 Optical receive signal
22 Optical-electrical converter unit
23 Electrical signal
24 Digital interface
25 CPU
26 Electrical return channel
27 Synthesis unit
28 Modulator
29 Optical control unit
30 Optical distributor
31 Control unit
32 A feedback loop
33 Electrical transmission path
34 Electrical control signal
35 Trajectory
36 Virtual antenna array
37 Virtual spatial grid model
38 Volume pixel
39 Virtual antenna array
40 to 43 Electrical emitted signals
44 Photodiode
45 Amplifier
46 to 48 Frequency conversion unit
49 Measuring positions
50 to 53 Amplifier
54 to 57 Electrical receive signals
58 Electronic unit 49
59 Carrier signal
60 Photodiode
61 Virtual receiving antenna
63 Distance spectrum
63 Beat signal
64 to 67 Partial spectrums
S10 to S20 Steps

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for determining at least one item of target information of a target object of a sensor system, which sensor system has multiple transmitting antennas and multiple receiving antennas, comprising:
emitting, in a transmission process, multiple electrical emitted signals, which are frequency shifted relative to one another, simultaneously by the multiple transmitting antennas into the surroundings;
receiving electrical receive signals, which are based on the emitted electrical emitted signals, by the multiple receiving antennas;
generating, on the basis of the received electrical receive signals, a virtual antenna array which has multiple virtual receiving antennas using defined antenna positions of the multiple transmitting antennas and defined antenna positions of the multiple receiving antennas;
performing a surroundings reconstruction of the surroundings on the basis of the virtual antenna array; and
determining the at least one item of target information on the basis of the surroundings reconstruction.

2. The method of claim 1, wherein a respective received electrical receive signal, which is allocated to a respective virtual receiving antenna of the virtual antenna array, is mixed with a carrier signal, on which the multiple electrical emitted signals, which are frequency shifted relative to one another, are based.

3. The method of claim 2, wherein a distance spectrum is determined for each virtual receiving antenna on the basis of the receive signal belonging to the respective receiving antenna and mixed with the carrier signal.

4. The method of claim 3, wherein a respective distance spectrum of a respective virtual receiving antenna is broken down into partial spectrums depending on an emitted electrical emitted signal corresponding to the receive signal and the transmitting antenna emitting said electrical emitted signal.

5. The method of claim 4, wherein the partial spectrums of a respective virtual receiving antenna are projected onto a virtual spatial grid model relating to the surroundings reconstruction, with which the surroundings can be modulated three-dimensionally, as a function of the transmitting antenna corresponding to a respective partial spectrum of the partial spectrums.

6. The method of claim 5, wherein the virtual spatial grid model is subdivided into multiple volume pixels, wherein a respective partial spectrum of the partial spectrums of a respective virtual receiving antenna is assigned to one volume pixel of the multiple volume pixels, on the basis of a relationship between the corresponding transmitting antenna and the virtual spatial grid model.

7. The method of claim 5, wherein a phase compensation filtering for compensating for a phase position of the respective partial spectrum in the virtual spatial grid model is performed for a respective partial spectrum, wherein the phase compensation filtering of a respective partial spectrum is performed on the basis of the transmitting antenna corresponding to the respective partial spectrum, the virtual receiving antenna of the respective partial spectrum and a frequency of the electrical emitted signal emitted by the transmitting antenna corresponding to the respective partial spectrum.

8. The method of claim 7, wherein the individual partial spectrums of a respective receiving antenna, in which the phase compensation filtering was performed, are integrated.

9. A sensor system having multiple transmitting antennas, multiple receiving antennas and one processor, wherein the sensor system is configured to:
emitting, in a transmission process, multiple electrical emitted signals, which are frequency shifted relative to one another, simultaneously by the multiple transmitting antennas into the surroundings;
receiving electrical receive signals, which are based on the emitted electrical emitted signals, by the multiple receiving antennas;
generating, on the basis of the received electrical receive signals, a virtual antenna array which has multiple virtual receiving antennas using defined antenna positions of the multiple transmitting antennas and defined antenna positions of the multiple receiving antennas;
performing a surroundings reconstruction of the surroundings on the basis of the virtual antenna array; and
determining at least one item of target information on the basis of the surroundings reconstruction.

10. A vehicle having a sensor system of claim 9.

11. The sensor system of claim 9, wherein a respective received electrical receive signal, which is allocated to a respective virtual receiving antenna of the virtual antenna array, is mixed with a carrier signal, on which the multiple electrical emitted signals, which are frequency shifted relative to one another, are based.

12. The sensor system of claim 11, wherein a distance spectrum is determined for each virtual receiving antenna on the basis of the receive signal belonging to the respective receiving antenna and mixed with the carrier signal.

13. The sensor system of claim 12, wherein a respective distance spectrum of a respective virtual receiving antenna is broken down into partial spectrums depending on an emitted electrical emitted signal corresponding to the receive signal and the transmitting antenna emitting said electrical emitted signal.

14. The sensor system of claim 13, wherein the partial spectrums of a respective virtual receiving antenna are projected onto a virtual spatial grid model relating to the surroundings reconstruction, with which the surroundings can be modulated three-dimensionally, as a function of the transmitting antenna corresponding to a respective partial spectrum of the partial spectrums.

15. The sensor system of claim 14, wherein the virtual spatial grid model is subdivided into multiple volume pixels, wherein a respective partial spectrum of the partial spectrums of a respective virtual receiving antenna is assigned to one volume pixel of the multiple volume pixels, on the basis of a relationship between the corresponding transmitting antenna and the virtual spatial grid model.

16. The sensor system of claim 14, wherein a phase compensation filtering for compensating for a phase position of the respective partial spectrum in the virtual spatial grid model is performed for a respective partial spectrum, wherein the phase compensation filtering of a respective partial spectrum is performed on the basis of the transmitting antenna corresponding to the respective partial spectrum, the virtual receiving antenna of the respective partial spectrum and a frequency of the electrical emitted signal emitted by the transmitting antenna corresponding to the respective partial spectrum.

17. The sensor system of claim 16, wherein the individual partial spectrums of a respective receiving antenna, in which the phase compensation filtering was performed, are integrated.
